(19) United States
(12) Patent Application Publication
(10) Pub. No.: US 2016/0230918 A1
(43) Pub. Date: Aug. 11, 2016

(54) VACUUM INSULATION PANEL AND METHOD FOR MANUFACTURING THE SAME

(71) Applicant: LG HAUSYS , LTD., Yeongdeungpo-Seoul (KR)

(72) Inventors: Ha-Na KIM, Seoul (KR); Seong-Moon JUNG, Daejeon (KR); Myung LEE, Suwon-si, Gyeonggi-do (KR); Eun-Joo KIM, Uiwang-si, Gyeonggi-do (KR)

(21) Appl. No.: 15/023,658

(22) PCT Filed: Sep. 4, 2014
(86) PCT No.: PCT/KR2014/008305

§ 371 Date: Mar. 21, 2016

(30) Foreign Application Priority Data
Sep. 26, 2013 (KR) 10-2013-0114221

(51) Int. Cl. F16L 59/065; B32B 27/08; B32B 9/04; B32B 27/32; B32B 27/36; B32B 15/08; B32B 3/04; B32B 27/30

(52) U.S. Cl. CPC F16L 59/065; B32B 3/04; B32B 27/08; B32B 27/306; B32B 27/32; B32B 27/36; B32B 15/08; B32B 9/045; B32B 2307/304

(57) ABSTRACT

A vacuum insulation panel includes a core, and an outer skin material for surrounding the core, wherein the outer skin material includes a bending portion formed at one side surface thereof and sealing portions formed at three side surfaces thereof. A method for manufacturing a vacuum insulation panel includes preparing an outer skin material envelope by forming sealing portions at two side surfaces of an outer skin material including a bending portion formed at one side surface thereof, inserting a core into the outer skin material envelope, decompressing the inside of the outer skin material envelope, and forming a sealing portion at one side surface of the outer skin material envelope.

### TECHNICAL FIELD

The present invention relates to a vacuum insulation panel and a method for manufacturing the same, and more particularly, to a vacuum insulation panel having excellent long-term durability and insulating properties, and a method for manufacturing the same. BACKGROUND ART

Vacuum insulation panels are used as highly-efficient, next-generation insulation panels, as they exhibit a low thermal conductivity that is one-eighth or less of that of general insulation panels.

In general, a vacuum insulation panel is evacuated to a pressure close to vacuum. However, as time elapses, the pressure inside the vacuum insulation panel is increased due to moisture and gas introduced from the outside, and therefore, the degree of vacuum of the vacuum insulation panel is gradually lowered. Consequently, as more and more moisture and gas are introduced from the outside, the thermal conductivity of the inside and surface of the vacuum insulation panel rapidly increases. Therefore, the vacuum insulation panel cannot maintain high insulating properties, and accordingly, the lifespan of the vacuum insulation panel decreases.

### DISCLOSURE

### Technical Problem

It is an aspect of the present invention to provide a vacuum insulation panel having excellent insulating properties and long-term durability by reducing the permeation of moisture and gas into the inside thereof.

It is another aspect of the present invention to provide a method for manufacturing the vacuum insulation panel.

The present invention is not limited to the above aspect and other aspects of the present invention will be clearly understood by those skilled in the art from the following description.

### Technical Solution

In accordance with one aspect of the present invention, a vacuum insulation panel includes a core, and an outer skin material for surrounding the core, wherein the outer skin material includes a bending portion formed at one side surface thereof and sealing portions formed at three side surfaces thereof

The outer skin material may be a multi-layer film formed symmetric about the bending portion.

The multi-layer film may include a laminated structure of a sealing layer, a barrier layer, a resin layer, and a protective layer.

The sealing layer may include linear low density poly ethylene (LLDPE) or cast poly propylene (CPP).

The barrier layer may include at least one selected from the group consisting of aluminum foil, alumina (Al₂O₃), and silica (SiOx).

The resin layer may include at least one selected from the group consisting of nylon resin, polyethylene terephthalate (PET), poly vinyl alcohol (PVOH), and ethylene vinyl alcohol (EVOH).

The protective layer may include at least one selected from the group consisting of polyethylene terephthalate (PET), nylon resin, and poly vinyl alcohol (PVOH).

The multi-layer film may include a laminated structure of a sealing layer, a resin layer, a first barrier layer, and a second barrier layer.

The sealing layer may include linear low density poly ethylene (LLDPE) or cast poly propylene (CPP).

The resin layer may include at least one selected from nylon resin, polyethylene terephthalate (PET), poly vinyl alcohol (PVOH), and ethylene vinyl alcohol (EVOH).

The first barrier layer and the second barrier layer may include vacuum metalized polyethylene terephthalate (VM-PET).

The sealing portions may be formed by heat-sealing sealing layers opposite to each other as the multi-layer film is folded in half about the bending portion.

The vacuum insulation panel may further include a getter inserted between the core and the outer skin material.

In accordance with one aspect of the present invention, a method for manufacturing a vacuum insulation panel includes preparing an outer skin material envelope by forming sealing portions at two side surfaces of an outer skin material including a bending portion formed at one side surface thereof, inserting a core into the outer skin material envelope, decompressing the inside of the outer skin material envelope, and forming a sealing portion at the other side surface of the outer skin material envelope.

The preparing an outer skin material envelope may include folding, in half, a multi-layer film which is symmetric about the bending portion.

The preparing an outer skin material envelope may further include forming the sealing portions by heat-sealing sealing layers facing each other as the multi-layer film is folded in half about the bending portion.

The decompressing the inside of the outer skin material envelope may include decompressing the inside of the outer skin material envelope such that the pressure inside the outer skin material envelope becomes 0 Pa to 10 Pa.

### Advantageous Effects

According to the present invention, the vacuum insulation panel can decrease the permeation of moisture and gas thereinto, and can reduce the heat-bridge effect thereof, thereby achieving excellent insulating properties and long-term durability.

Also, the method can provide a vacuum insulation panel having excellent insulating properties and long-term durability.

### DESCRIPTION OF DRAWINGS

FIG. 1 shows a vacuum insulation panel according to an embodiment of the present invention.

FIG. 2 shows a cross section of the vacuum insulation panel.

FIG. 3 shows a cross section of an outer skin material of the vacuum insulation panel.

FIG. 4 shows a cross section of an outer skin material according to another embodiment of the present invention.

FIG. 5 shows a process of preparing a conventional outer skin material.

FIG. 6 shows a process of preparing an outer skin material envelope according to an embodiment of the present invention.

FIG. 7 is a graph depicting thermal conductivity increasing rates of an embodiment and Comparative Example, which are shown in Table 1.

FIG. 8 is a graph depicting thermal conductivities of the embodiment and Comparative Example, which are shown in Table 2.

### BEST MODE

Hereinafter, embodiments of the present invention will be described in detail with reference to the accompanying drawings. It should be understood that the present invention is not limited to the following embodiments, and that the embodiments are provided for illustrative purposes only. The scope of the invention should be defined only by the accompanying claims and equivalents thereof.

For clarity of description, parts unrelated to description may be omitted, and the same reference numbers will be used throughout this specification to refer to the same or like parts.

In the drawings, lengths of regions may be reduced or exaggerated for clarity.

It will be understood that when an element such as a layer, region, substrate, or panel is referred to as being “on” or “under” another element, it can be directly on or under the other element or intervening elements may also be present.

Vacuum Insulation Panel

An embodiment of the present invention provides a vacuum insulation panel including a core, and an outer skin material for surrounding the core, wherein the outer skin material includes a bending portion formed at one side surface thereof and sealing portions formed at three side surfaces thereof.

In general, a vacuum insulation panel is manufactured by surrounding a core with an outer skin material and decompressing the inside of the outer skin material. The outer skin material used in manufacturing of the vacuum insulation panel includes two sheets of film. The vacuum insulation panel may be manufactured by wrapping the core with the two sheets of film facing each other and then sealing four side surfaces between the two sheets of film. Thus, after the vacuum insulation panel is manufactured, sealing portions formed at four side surfaces of the outer skin material are exposed to the outside.

As the vacuum insulation panel thus manufactured is used, moisture and gas may permeate into the vacuum insulation panel. Accordingly, as time elapses, the thermal conductivity of the vacuum insulation panel increases, and therefore, the thermal insulation performance of the vacuum insulation panel decreases. The majority of the moisture and gas from the outside permeate into the vacuum insulation panel through the sealing portions formed at the four side surfaces.

Also, as more and more moisture and gas permeate into the vacuum insulation panel, the thermal conductivity of the inside and surface of the vacuum insulation panel rapidly increases. Therefore, the vacuum insulation panel cannot maintain high insulating properties, and the lifespan of the vacuum insulation panel decreases.

In general, sealing portions are folded to fit the size of a core such that a vacuum insulation panel has a size suitable to be applied to an apparatus. In this case, all of the four side surfaces of the sealing portions formed by using two outer skin material films are to be folded. In particular, the outer skin material film is folded twice at each of corners, and therefore, the outer skin material film is likely to be torn, so that a leak may occur. The leak occurring at the corners of the vacuum insulation panel may result in decrease in insulating properties and durability and may increase defects in processing and transportation of the vacuum insulation panel.

In view of the above, a vacuum insulation panel according to an embodiment of the present invention includes a core and an outer skin material for surrounding the core, wherein the outer skin material includes a bending portion formed at one side surface thereof and sealing portions formed at three side surfaces thereof. Accordingly, the number of sealing portions can be decreased, and an increase in thermal conductivity, caused by moisture and gas permeating from the outside, can be prevented, thereby improving insulating properties and long-term durability.

In addition, as the number of sealing portions is reduced, so is the number of corners at which the outer skin material film is folded twice, thereby further improving insulating properties and long-term durability.

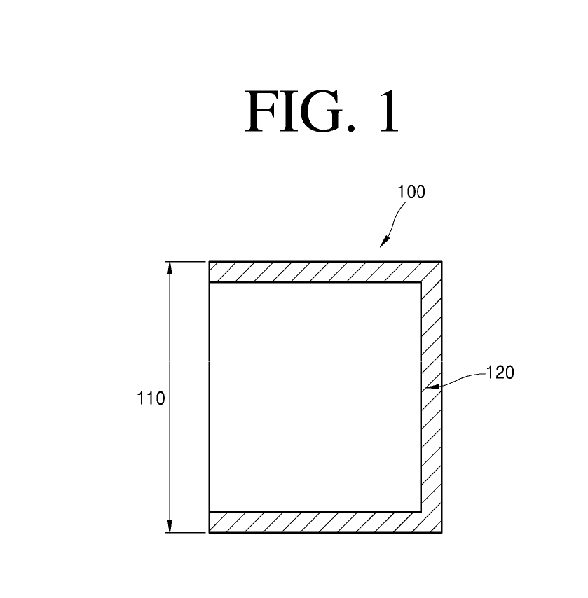

FIG. 1 shows a vacuum insulation panel 100 according to an embodiment of the present invention, which includes an envelope including a bending portion formed at one side surface thereof and sealing portions formed at three side surfaces thereof.

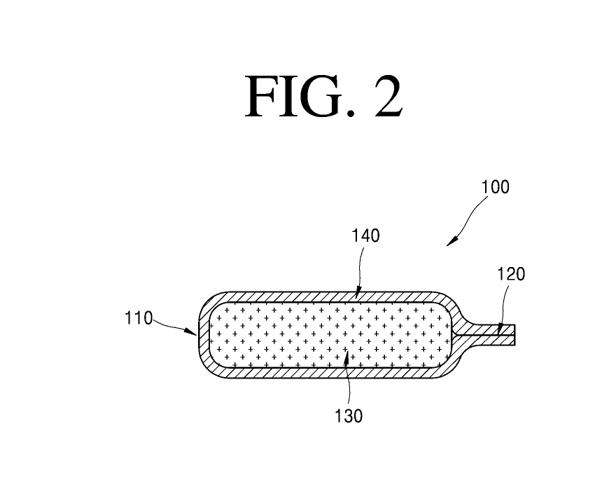

FIG. 2 shows a cross section of the vacuum insulation panel 100 according to the embodiment of the present invention.

Referring to FIGS. 1 and 2, the vacuum insulation panel 100 according to the embodiment of the present invention includes a core 130 and an outer skin material 140 for surrounding the core 130. The outer skin material 140 includes a bending portion 110 formed at one side surface thereof and sealing portions 120 formed at three side surfaces thereof.

The core 130 includes an inorganic compound that has a low thermal conductivity and generates little gas. The core 130 may include at least one selected from the group consisting of glass fiber, fumed silica, silica board, organic fiber, and organic foam. Particularly, when the core 130 includes a plate-shaped laminate formed by thermally compressing glass fiber or fumed silica, the core 130 exhibits excellent thermal insulation performance.

The outer skin material 140 may be a multi-layer film that is symmetric about the bending portion 110. Typically, the outer skin material 140 is larger than the core 130 to easily surround the core 130. The multi-layer film may be a single film having a laminated structure.

The bending portion 110 is a line about which the multi-layer is folded in half, and is a folded portion after the multi-layer film has been folded in half. The bending portion 110 comes in contact with the core 130 with no gap therebetween, and accordingly, external gas and moisture cannot permeate into the vacuum insulation panel, thereby improving the thermal insulation performance of the vacuum insulation panel.

The sealing portion 120 is formed by heat sealing two side surfaces facing each other to thermally fuse them together when the multi-layer film is folded in half about the bending portion 110.

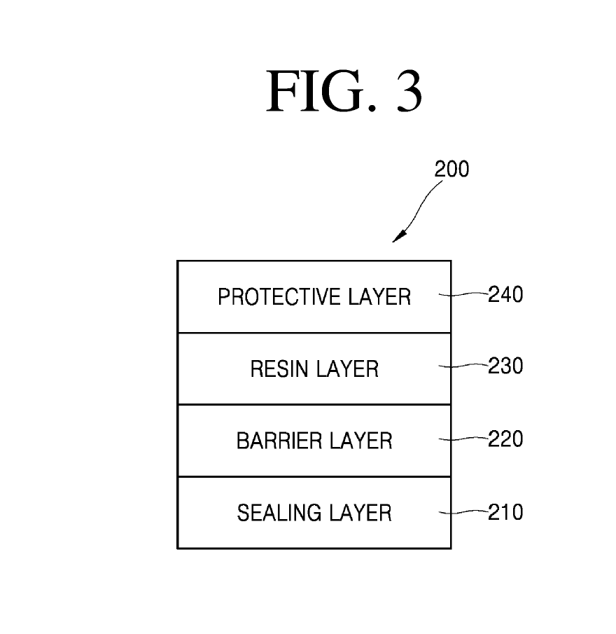

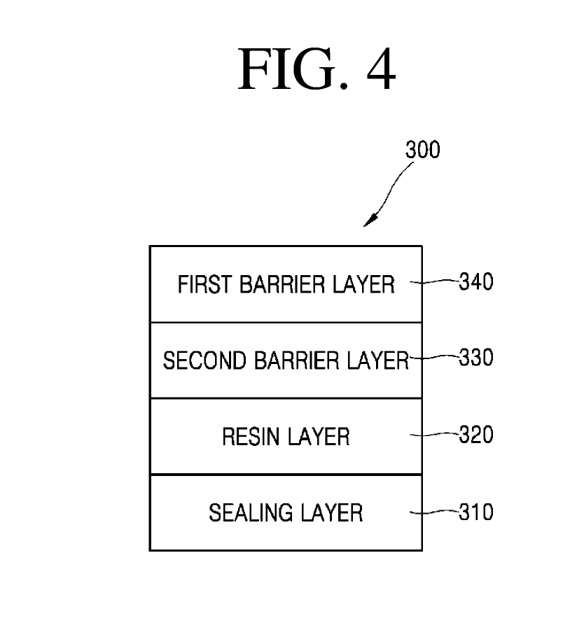

FIG. 3 shows a cross section of a multi-layer film 200 as the outer skin material of the vacuum insulation panel. FIG. 4 shows a cross section of a multi-layer film 300 as the outer skin material according to another embodiment of the present invention.

Referring to FIG. 3, the multi-layer film 200 may include a laminated structure of a sealing layer 210, a barrier layer 220, a resin layer 230, and a protective layer 240. For example, the sealing layer 210, the barrier layer 220, the resin layer 230, and the protective layer 240 may be sequentially laminated from the bottom of the multi-layer film 200.

Referring to FIG. 4, the multi-layer film 300 may include a laminated structure of a sealing layer 310, a resin layer 320, a first barrier layer 330, and a second barrier layer 340. For example, the sealing layer 310, the resin layer 320, the first barrier layer 330, and the second barrier layer 340 may be sequentially laminated from the bottom of the multi-layer film 300.

Referring to FIGS. 3 and 4, the sealing layer 210 or 310 is the lowest layer of the multi-layer film, and the sealing portion 120 is formed by heat sealing two surfaces of the sealing layer 210 or 310 facing each other to thermally fuse them together when the multi-layer film is folded in half. The sealing layer may include at least one selected from the group consisting of linear low density poly ethylene (LLDPE) or low density poly ethylene (LDPE), high density poly ethylene (HDPE), cast poly propylene (CPP), oriented poly propylene (OPP), poly vinylidene chloride (PVDC), poly vinyl chloride (PVC), ethylene-vinyl acetate copolymer (EVA), and ethylene-vinyl alcohol copolymer (EVOH). For example, the sealing layer may include linear low density poly ethylene (LLDPE) that is easily subjected to thermal fusion and has excellent sealing properties or cast poly propylene (CPP) having excellent moisture-proof properties.

The thickness of the sealing layer 210 or 310 may be about 20 μm to about 60 μm. For example, the thickness of the sealing layer 210 or 310 may be about 30 μm to about 50 μm. When the thickness of the sealing layer is less than about 20 μm, the separation strength by the sealing layer is weak, and hence cannot achieve sufficient sealing effect. When the thickness of the sealing layer exceeds about 60 μm, the amount of external gas and moisture permeating through the sealing layer increases, and therefore, the long-term durability of the vacuum insulation panel may be lowered. Also, it is difficult to form the bending portion, and therefore, the processability of the vacuum insulation panel may be deteriorated.

Referring to FIG. 3, the barrier layer 220 is formed on the sealing layer 210, and effectively maintains the degree of vacuum inside the vacuum insulation panel by preventing the permeation of external gas or moisture.

The barrier layer 220 may include at least one selected from aluminum foil, alumina (Al₂O₃), and silica (SiOₓ). Aluminum has a high thermal conductivity, and hence may decrease the thermal insulation performance of the vacuum insulation panel. Thus, an inorganic material such as alumina or silica is mixed with aluminum foil, so that the barrier performance of the aluminum foil can be supplemented.

The thickness of the barrier layer 220 may be about 5 μm to about 10 μm. When the thickness of the barrier layer 220 is less than about 5 μm, the long-term durability of the vacuum insulation panel is lowered. When the thickness of the barrier layer 220 exceeds about 10 μm, the increasing rate of thermal conductivity is increased due to a heat-bridge effect. Also, cracks, etc. occur when the bending portion is formed, and therefore, the processability of the vacuum insulation panel may be deteriorated. For example, when the barrier layer 220 includes aluminum foil, the thickness of the barrier layer 220 may be about 6 μm to about 7 μm.

Referring to FIG. 3, the resin layer 230 and the protective layer 240 is formed on the barrier layer 220, and protects the surface of vacuum insulation panel or the internal core from external impact.

The resin layer 230 may include at least one selected from nylon resin, polyethylene terephthalate (PET), poly vinyl alcohol (PVOH), and ethylene vinyl alcohol (EVOH). For example, the resin layer 230 may include nylon resin having excellent flexibility and impact resistance. The thickness of the resin layer 230 may be about 10 μm to about 40 μm. When the thickness of the resin layer 230 is less than about 10 μm, the internal core may be broken by an impact, scratch, etc. When the thickness of the resin layer 230 is less than about 40 μm, the manufacturing cost of the vacuum insulation panel may increase, and it is difficult to bend the multi-layer film 200, thereby deteriorating the processability of the vacuum insulation panel. For example, the resin layer 230 includes nylon resin, the thickness of the resin layer 230 may be about 15 μm to about 25 μm.

The protective layer 240 may include at least one selected from polyethylene terephthalate (PET), nylon resin, and poly vinyl alcohol (PVOH). For example, the protective layer 240 may include polyethylene terephthalate (PET) having excellent impact resistance and an excellent ability of preventing the permeation of gas or moisture. The thickness of the protective layer 240 may be about 5 μm to about 20 μm. When the thickness of the protective layer 240 is less than about 5 μm, the protective layer 240 may not ensure, as an outermost layer, impact resistance and a function of protecting the surface of the vacuum insulation panel. When the thickness of the protective layer 240 exceeds about 20 μm, the entire thickness of the multi-layer film is excessively increased, and therefore, it is disadvantageous to form the bending portion, thereby deteriorating the processability of the vacuum insulation panel. For example, the protective layer 240 includes polyethylene terephthalate (PET), the thickness of the protective layer 240 may be about 10 μm to about 15 μm.

Referring to FIG. 4, the resin layer 320 is formed on the sealing layer 310, and protects the surface of the vacuum insulation panel or the internal core from external impact. The resin layer 320 may include at least one selected from poly vinyl alcohol (PVOH), nylon resin, polyethylene terephthalate (PET), and ethylene vinyl alcohol (EVOH). For example, the resin layer 320 may include poly vinyl alcohol (PVOH). The thickness of the resin layer 320 may be about 5 μm to about 25 μm. When the thickness of the resin layer 320 is less than about 5 μm, the internal core may be broken by an impact, scratch, etc. When the thickness of the resin layer 320 exceeds about 25 μm, the manufacturing cost of the vacuum insulation panel may increase, and it is disadvantageous to form the bending portion, thereby deteriorating the processability of the vacuum insulation panel. For example, when the resin layer 320 includes poly vinyl alcohol (PVOH), the thickness of the resin layer 320 may be about 12 μm to about 25 μm. When the resin layer 320 includes ethylene vinyl alcohol (EVOH), the thickness of the resin layer 320 may be about 10 μm to about 20 μm.

Referring to FIG. 4, the first barrier layer 330 and the second barrier layer 340 are formed on the resin layer 320, and prevent the permeation of external gas or moisture. In addition, the first barrier layer 330 and the second barrier layer 340 are outermost layers having impact resistance and protect the surface and inside of the vacuum insulation panel from external pressure or impact.

Each of the first and second barriers 330 and 340 may include, instead of a single-layer aluminum foil, a vacuum metalized polyethylene terephthalate (VM-PET) film formed by depositing a metal on one surface of a polyethylene terephthalate film. For example, the VM-PET film may be an aluminum vacuum metalized polyethylene terephthalate film. The aluminum vacuum metalized polyethylene terephthalate film is formed by thinly depositing aluminum on one surface of a PET film. For example, the aluminum may be deposited through sputtering or vacuum deposition.

When each of the first and second barriers 330 and 340 includes the vacuum metalized polyethylene terephthalate (VM-PET) film, it is advantageous to maintain the degree of vacuum inside the vacuum insulation panel and improve the thermal insulation performance of the vacuum insulation panel. Hence, it is possible to prevent the thermal insulation performance of the vacuum insulation panel from being decreased due to a high thermal conductivity of the single-layer aluminum foil.

The thickness of each of the first and second barrier layers 330 and 340 may be about 10 μm to about 15 μm. When the thickness of each of the first and second barrier layers 330 and 340 is less than about 10 μm, each of the first and second barrier layers 330 and 340 effectively prevents the permeation of moisture and gas, and therefore, the long-term durability of the vacuum insulation panel may be lowered. When the thickness of each of the first and second barrier layers 330 and 340 exceeds about 15 μm, the thermal conductivity of the vacuum insulation panel is increased due to the head-bridge phenomenon, or it is difficult to form the bending portion. Therefore, the processability of the vacuum insulation panel may be deteriorated. For example, when each of the first and second barrier layers 330 and 340 includes the aluminum vacuum metalized polyethylene terephthalate film, the thickness of each of the first and second barrier layers 330 and 340 may be about 11 μm to about 13 μm.

In the case of the VM-PET film, the thickness of the deposited metal may be about 11 nm to about 1000 nm. When the thickness of the metal is less than about 5 nm, the thickness of the metal is too thin, and therefore, a crack or defect may occur. When the thickness of the metal exceeds about 1000 nm, it may take too long to manufacture the vacuum insulation panel, incurring excessively high cost.

In the multi-layer film 200 or 300, each layer of the laminated structure may be adhered to another by an adhesive layer.

The adhesive layer may include a polyurethane-based adhesive, and the thickness of the adhesive layer may be about 2 μm to about 3 μm. When the thickness of the adhesive layer is less than about 2 μm, the adhesive layer may fail to ensure a sufficient adhesion for adhering each layer, and it is likely that a large amount of moisture and gas will permeate from the outside due to a gap between the adhesive layer and each layer. When the thickness of the adhesive layer exceeds about 3 μm, the thickness of the multi-layer film increases, and hence it is difficult to bend the multi-layer film. Therefore, the processability of the vacuum insulation panel is deteriorated, which is disadvantageous in terms of economical efficiency.

A vacuum insulation panel according to another embodiment of the present invention includes a core and an outer skin material for surrounding the core, wherein the outer skin material includes a bending portion formed at one side surface thereof and sealing portions formed at three side surfaces. The vacuum insulation panel may further include a getter inserted between the core and the outer skin material.

The getter refers to a gas/moisture absorbent for absorbing gas and/or moisture that may remain inside the vacuum insulation panel or newly permeate from the outside.

The getter may include calcium oxide (CaO) and zeolite. The getter may include at least one of the group consisting of alloy (BaLi) of lithium and barium, cobalt oxide (CoO), and barium oxide (BaO), which absorbs oxygen, hydrogen, nitrogen, carbon dioxide, and vapor. The getter may be prepared in the shape of a block or rectangular parallelepiped. Also, the getter may be prepared by being coated or attached onto the surface of the core or the inner surface of the outer skin material.

The vacuum insulation panel includes a core and an outer skin material including a bending portion formed at one edge surface thereof and sealing portions formed at three side surfaces thereof, so that the number of sealing portions can be decreased. Accordingly, it is possible to reduce the amount of moisture and gas being introduced from the outside and prevent the heat-bridge effect, thereby achieving excellent insulating properties and long-term durability.

Method for Manufacturing Vacuum Insulation Panel

An embodiment of the present invention provides a method for manufacturing a vacuum insulation panel, which includes preparing an outer skin material envelope by forming sealing portions at two side surfaces of an outer skin material film including a bending portion formed at one side surface thereof; inserting a core into the outer skin material envelope; decompressing the inside of the outer skin material envelope; and forming a sealing portion at one side surface of the outer skin material envelope.

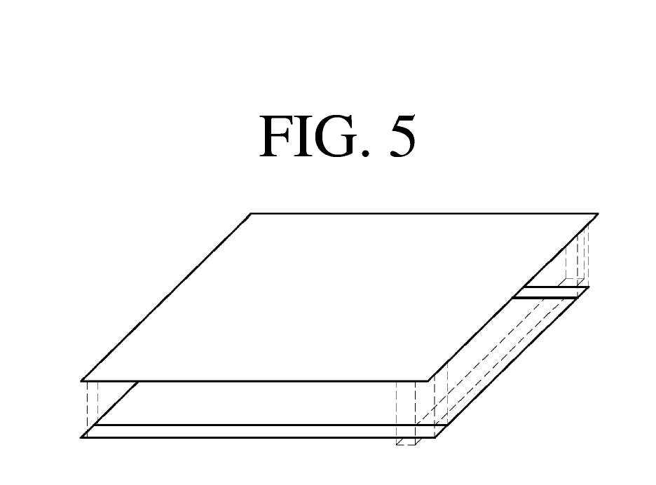

FIG. 5 shows a process of preparing a conventional outer skin material envelope.

Referring to FIG. 5, two sheets of film are disposed facing each other, and three of four side surfaces between the two sheets of the film are sealed, leaving the one side surface open. Then, a core is inserted into the outer skin material, and the one side surface is then sealed, thereby manufacturing a vacuum insulation panel including sealing portions formed at a total of four side surfaces. The vacuum insulation panel manufactured in this manner includes the sealing portions formed at the four side surfaces, which are exposed to the outside, and the thermal conductivity of the vacuum insulation panel is increased by moisture and gas permeating through the sealing portions. Therefore, the insulating properties and long-term durability of the vacuum insulation panel are lowered.

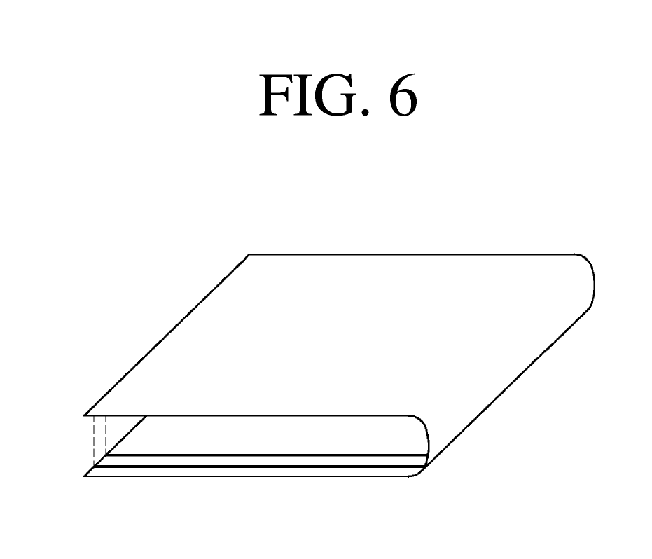

FIG. 6 shows a process of preparing an outer skin material envelope according to an embodiment of the present invention.

Referring to FIG. 6, in the processing of preparing the outer skin material envelope, the outer skin material envelope is prepared with one sheet of film, instead of two. The processing of preparing the outer skin material envelope includes folding, in half, a multi-layer having a symmetric structure using a bending portion as an axis. The bending portion has been described above.

Also, the processing of preparing the outer skin material envelope may further include forming sealing portions at two side surfaces by heat-sealing sealing layers opposite to each other as the multi-layer film is folded in half. The sealing portions formed at the two side surfaces may be adjacent to each other or opposite to each other.

As such, the outer skin material envelope including the bending portion formed at one side surface thereof and the sealing portions at two side surface surfaces thereof is prepared, so that it has a less number of sealing portions than the conventional outer skin material envelope. Accordingly, less moisture and gas are introduced from the outside, so that it is possible to prevent an increase in thermal conductivity and a heat-bridge effect, thereby achieving excellent insulating properties and long-term durability.

The method for manufacturing the vacuum insulation panel may include inserting a core into the outer skin material envelope. The core has been described above.

The method for manufacturing the vacuum insulation panel may further include decompressing the inside of the outer skin material envelope. As the inside of the outer skin material envelope is decompressed, a vacuum pressure is created inside the vacuum insulation panel, thereby removing gas and moisture. Thus, it is possible to decrease the thermal conductivity of the inside and surface of the vacuum insulation panel and improve the thermal insulation performance of the vacuum insulation panel.

In the decompressing the inside of the outer skin material envelope, the inside of the outer skin material envelope may be decompressed such that the internal pressure of the outer skin material envelope becomes about 0 Pa to about 10 Pa. For example, the inside of the outer skin material envelope may be decompressed such that the internal pressure of the outer skin material envelope becomes about 0 Pa to about 4 Pa. For example, the inside of the outer skin material envelope may be decompressed such that the internal pressure of the outer skin material envelope becomes about 0 Pa to about 1 Pa. When the internal pressure of the outer skin material envelope exceeds 10 Pa, the thermal insulation performance of the vacuum insulation panel may not be ensured.

Through the method for manufacturing the vacuum insulation panel, it is possible to a vacuum insulation panel having an outer skin material including a bending portion formed at one side surface thereof and sealing portions formed at three side surfaces thereof. In the vacuum insulation panel, the number of sealing portions is decreased, so that it is possible to prevent moisture and gas from permeating from the outside, thereby achieving excellent insulating properties and long-term durability.

Hereinafter, specific embodiments of the present invention will be proposed. However, the following embodiments are merely provided for exemplifying or illustrating the present invention. Accordingly, the present invention is not limited to the following embodiments.

### EMBODIMENT AND COMPARATIVE EXAMPLE

### Embodiment

<Preparation of Core>

A glass fiber having an average diameter of 4 μm was dispersed in a water glass (binder), to produce sheets of glass fiber board, thickness of each sheet being equal to 1 mm. The thirty sheets of the glass fiber board were stacked on one another, and were decompressed to reduce the thickness to 5%, to produce the core.

<Preparation of Outer Skin Material>

A multi-layer film was formed as an outer skin material by sequentially laminating, from the outside, a polyethylene terephthalate (PET) film having a thickness of 12 μm, a nylon film having a thickness of 25 μm, an aluminum foil having a thickness of 7 μm, and a linear low density poly ethylene (LLDPE) film having a thickness of 50 μm by using a polyurethane-based adhesive.

Alternatively, a multi-layer film was formed as an outer skin material by sequentially laminating, from the outside, two sheets of PET film (a total thickness of 12 μm), a poly vinyl alcohol (PVOH) film (a thickness of 15 μm), and a cast poly propylene (CPP) film (a thickness of 30 μm) by using a polyurethane-based adhesive. Here, the PET film was formed by laminating aluminum (Al) on one surface thereof in a thickness of 0.07 μm(an Al layer faced toward the core).

Each layer of the outer skin material was prepared by laminating films by using the following method.

The films were dry-laminated by using a two-liquid urethane-based adhesive. First, two films were dry-laminated. Subsequently, a film is further dry-laminated on the dry-laminated film and then aged. Additionally, a film to be laminated was dry-laminated and then aged, thereby preparing the outer skin material. The adhesive was cured by performing the aging at a temperature of 45° C.

<Manufacturing of Vacuum Insulation Panel>

A bending portion was formed by folding an outer skin material film having a size of 400×520 mm (width×length) in half in its width direction as shown in FIG. 6, and two side surface of the folded outer skin material were thermally fused through heat-sealing, thereby preparing an outer skin material envelope.

The core was inserted into the outer skin material envelope, and two getters were inserted between the surface of the core and the outer skin material. The getter was prepared by putting quicklime (CaO) having a purity of 95% and a specific surface of 8 m²/g into a pouch formed with a wrinkled paper and a felt immersed with polypropylene.

The inside of the outer skin material envelope was decompressed to a pressure of 4 Pa, and the other edge surface was heat-sealed, thereby manufacturing a vacuum insulation panel having a size of 8×190×250 mm (thickness×width×length).

### Comparative Example

A vacuum insulation panel having a size 8×190×250 mm (thickness×width×length) was manufactured by using the same method, except that two sheets of outer skin material having a size of 200×260 mm (width×length) were prepared, and an outer skin material envelope was prepared by thermally fusing three side surfaces of the two outer skin material opposite to each other as shown in FIG. 5.

### Evaluation

### Experimental Example 1

### Measurement Values of Thermal Conductivity Increasing Rates for Evaluating Improvement of Long-Term Durability

The thermal conductivities in mW/mK of center portions of the vacuum insulating panels of the embodiment and Comparative Example were measured at every 15 days interval, with the vacuum insulating panels of the embodiment and Comparative Example put in a chamber at a temperature of 70° C. and a relative humidity of 90%.

The center portion is defined as an area having a size of 75×75 mm located in the center of the vacuum insulation panel having a size of 190×250 memory. The center portion has four side surfaces parallel to the respective side surfaces of the cross section of the vacuum insulation panel.

A thermal conductivity measurement sensor was located at the center portion. Thermal conductivities of the vacuum insulation panels of the embodiment and Comparative Example were measured with the sensor.

Thermal conductivity increasing rates in % were calculated by General Expression 1 below, in terms of thermal conductivities of the embodiment and Comparative Example, which were measured at every 15 days internal for 60 days. The calculated thermal conductivity increasing rates are shown in Table 1 below:

[General Expression 1]

Thermal conductivity increasing rate (%)=(last thermal conductivity−initial thermal conductivity)/initial thermal conductivity×100

where initial thermal conductivity denotes a thermal conductivity measured on the first day of the period of 15 days, and a last thermal conductivity denotes a thermal conductivity measured on the fifteenth day of the period of 15 days.

TABLE 1

| Aging Time | Embodiment | Comparative Example |
|---|---|---|
| First Period (1 to 15 days) | 11.94% | 13.44% |
| Second Period (16 to | 10.44% | 12.67% |
| 30 days) | | |
| Third Period (31 to | 8.53% | 10.40% |
| 45 days) | | |
| Fourth Period (46 to | 9.75% | 11.80% |
| 60 days) | | |

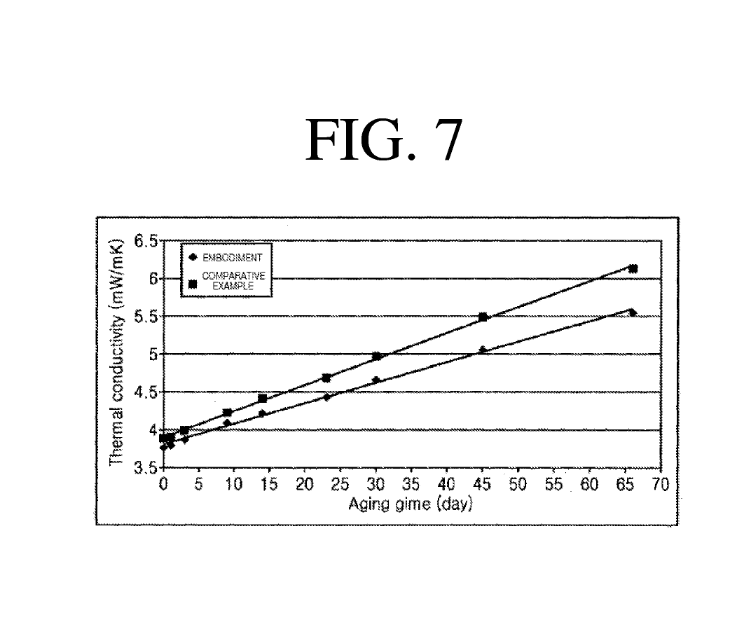

FIG. 7 is a graph depicting thermal conductivities of an embodiment and Comparative Example, which are shown in Table 1. As the thermal conductivity of the vacuum insulation panel increases, the thermal insulation performance of the vacuum insulation panel decreases. Hence, the long-term durability of the vacuum insulation panel may be expressed as a thermal conductivity increasing rate. That is, as the thermal conductivity increasing rate becomes lower, the long-term durability becomes higher.

According to FIG. 7 and Table 1, it can be seen that the thermal conductivity increasing rate of each period in Comparative Example is greater than the thermal conductivity increasing rate of each period in the embodiment. Thus, it can be seen that the long-term durability of the embodiment having an outer skin material including the bending portion formed at the one side surface thereof and the sealing portions formed at the three side surfaces thereof is superior to the long-term durability of Comparative Example having the outer skin material including the sealing portions formed at the four side surfaces thereof.

### Experimental Example 2

### Measurement Values of Thermal Conductivities for Evaluating Improvement of Insulating Properties

A thermal conductivity of the vacuum insulation panel according to the embodiment was measured at every 1 cm on the straight line from the center portion to the bending portion. A thermal conductivity of the vacuum insulation panel according to the Comparative Example was measured at every 1 cm on the straight line from the center portion to the side surface corresponding to the bending portion. The measured results were shown in Table 2 below. The center portion has already been described above.

TABLE 2

| | |
|---|---|
| Distance from Center | Thermal Conductivity [mW/mK] |

| Portion [cm] | Embodiment | Comparative Example |
|---|---|---|
| 0 | 3.63 | 3.81 |
| 1 | 3.69 | 3.85 |
| 2 | 3.80 | 4.02 |
| 3 | 4.12 | 4.50 |
| 4 | 4.96 | 5.38 |
| 5 | 7.21 | 8.15 |
| 6 | 15.44 | 18.22 |

In the conventional vacuum insulation panel, the sealing portions formed at the four side surfaces are exposed to the outside. Hence, external moisture and gas permeate through the sealing portions, and therefore, the thermal conductivities of portions near the edges increase. As such, if the thermal conductivity of a portion of a structure increases, the portion forms a thermally weak portion that transfers heat more easily than other portions. This portion is referred to as a heat bridge, and the formation of this portion is referred to as a heat-bridge effect. The heat-bridge effect results in decrease in the thermal insulation performance of the vacuum insulation panel.

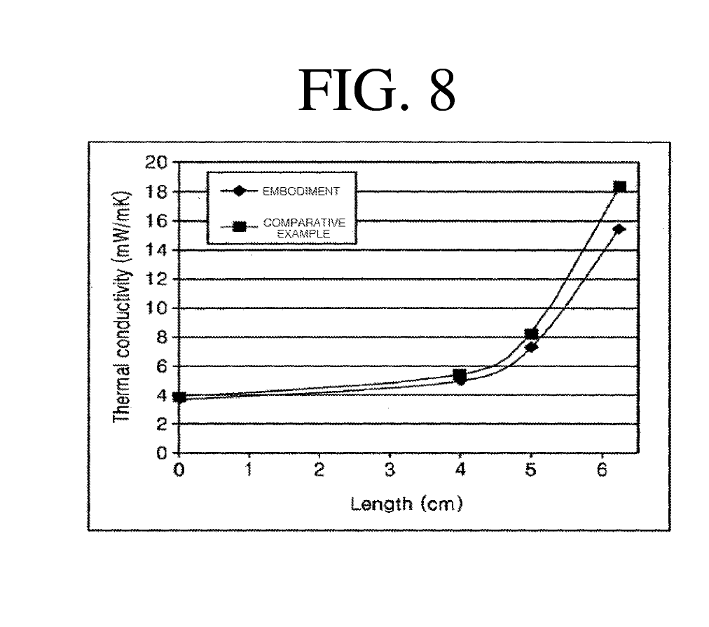

Experimental Example 2 was conducted to measure heat-bridge effects of the embodiment and the comparative example. FIG. 8 is a graph depicting thermal conductivities of Table 2.

Referring to FIG. 8, thermal conductivity measurement values of the embodiment are lower than thermal conductivity measurement values of the comparative example. Hence, it can be seen that the heat-bridge effect of the vacuum insulation panel of the embodiment, which is manufactured to have the outer skin material including the bending portion formed at the one side surface thereof and the sealing portions formed at the three side surfaces thereof is decreased as compared with the vacuum insulation panel of the comparative example, which is manufactured to have the outer skin material including the sealing portions at the four side surfaces thereof. Thus, the number of sealing portions included in the outer skin material is decreased, so that it is possible to improve the thermal insulation performance of the vacuum insulation panel.

According to the present invention, the vacuum insulation panel can decrease the permeation of moisture and gas thereinto, and can reduce the heat-bridge effect thereof, thereby achieving excellent insulating properties and long-term durability.

Also, the method can provide a vacuum insulation panel having excellent insulating properties and long-term durability.

### DESCRIPTION OF REFERENCE NUMERALS

100: vacuum insulation panel

110: bending portion

120: sealing portion

130: core

140: outer skin material

200; 300: multi-layer film

210; 310: multi-layer film

230; 320: resin layer

220: barrier layer

240: protective layer

330: second barrier layer

340: first barrier layer

1. A vacuum insulation panel comprising:
a core; and
an outer skin material for surrounding the core,
wherein the outer skin material includes a bending portion formed at one side surface thereof and sealing portions formed at three side surfaces thereof.

2. The vacuum insulation panel according to claim 1, wherein the outer skin material is a multi-layer film formed symmetric about the bending portion.

3. The vacuum insulation panel according to claim 2, wherein the multi-layer film includes a laminated structure of a sealing layer, a barrier layer, a resin layer, and a protective layer.

4. The vacuum insulation panel according to claim 3, wherein the sealing layer includes linear low density poly ethylene (LLDPE) or cast poly propylene (CPP).

5. The vacuum insulation panel according to claim 3, wherein the barrier layer includes at least one selected from the group consisting of aluminum foil, alumina (Al2O3), and silica (SiOx).

6. The vacuum insulation panel according to claim 3, wherein the resin layer includes at least one selected from the group consisting of nylon resin, polyethylene terephthalate (PET), poly vinyl alcohol (PVOH), and ethylene vinyl alcohol (EVOH).

7. The vacuum insulation panel according to claim 3, wherein the protective layer includes at least one selected from the group consisting of polyethylene terephthalate (PET), nylon resin, and poly vinyl alcohol (PVOH).

8. The vacuum insulation panel according to claim 2, wherein the multi-layer film includes a laminated structure of a sealing layer, a resin layer, a first barrier layer, and a second barrier layer.

9. The vacuum insulation panel according to claim 8, wherein the sealing layer includes linear low density poly ethylene (LLDPE) or cast poly propylene (CPP).

10. The vacuum insulation panel according to claim 8, wherein the resin layer includes at least one selected from nylon resin, polyethylene terephthalate (PET), poly vinyl alcohol (PVOH), and ethylene vinyl alcohol (EVOH).

11. The vacuum insulation panel according to claim 8, wherein the first barrier layer and the second barrier layer include vacuum metalized polyethylene terephthalate (VM-PET).

12. The vacuum insulation panel according to claim 1, wherein the sealing portions are formed by heat-sealing sealing layers opposite to each other as the multi-layer film is folded in half about the bending portion.

13. The vacuum insulation panel according to claim 1, further comprising a getter inserted between the core and the outer skin material.

14. A method for manufacturing a vacuum insulation panel, the method comprising:
preparing an outer skin material envelope by forming sealing portions at two side surfaces of an outer skin material including a bending portion formed at one side surface thereof;
inserting a core into the outer skin material envelope;
decompressing the inside of the outer skin material envelope; and
forming a sealing portion at the other side surface of the outer skin material envelope.

15. The method according to claim 14, wherein the preparing an outer skin material envelope comprises folding, in half, a multi-layer film formed symmetric about the bending portion.

16. The method according to claim 15, wherein the preparing an outer skin material envelope further comprises forming the sealing portions by heat-sealing sealing layers facing each other as the multi-layer film is folded in half about the bending portion.

17. The method according to claim 14, wherein the decompressing the inside of the outer skin material envelope comprises decompressing the inside of the outer skin material envelope such that the pressure inside the outer skin material envelope becomes 0 Pa to 10 Pa.
